(19) United States
(12) Patent Application Publication
(10) Pub. No.: US 2026/0104244 A1
(43) Pub. Date: Apr. 16, 2026

(54) SHAPE PROFILE MEASUREMENT DEVICE, SHAPE PROFILE MEASUREMENT METHOD, AND SEMICONDUCTOR MANUFACTURING METHOD INCLUDING THE SAME

(71) Applicant: Samsung Electronics Co., Ltd., Suwon-si (KR)

(72) Inventors: Hyunsoo Kwak, Suwon-si (KR); Jungwon Kim, Daejeon-si (KR); Hyoungsu Choi, Daejeon-si (KR); Sungyoon Ryu, Suwon-si (KR); Younghoon Sohn, Suwon-si (KR); Jinho Bae, Daejeon-si (KR)

(73) Assignees: Samsung Electronics Co., Ltd., Suwon-si (KR); KOREA ADVANCED INSTITUTE OF SCIENCE AND TECHNOLOGY, Daejeon (KR)

(21) Appl. No.: 19/270,572

(22) Filed: Jul. 16, 2025

(30) Foreign Application Priority Data
Oct. 10, 2024 (KR) 10-2024-0138028
Dec. 2, 2024 (KR) 10-2024-0176901

(51) Int. Cl. G01B 9/02056; G01B 9/02

(52) U.S. Cl. CPC G01B 9/02058; G01B 9/02041; G01B 2210/56

(57) ABSTRACT

A shape profile measurement device includes a light source configured to generate and emit a light signal, a relay optical system configured to receive the light signal from the light source, perform axial chromatic aberration on the light signal, emit a chromatically dispersed light signal over a plurality of wavelengths to a measurement target, and output a reflected light signal reflected from the measurement target, wherein the chromatically dispersed light signal is focused at different positions along an optical axis of the light signal, a detector configured to detect a wavelength of the reflected light signal, among the plurality of wavelengths, received from the relay optical system; and a processor configured to calculate a shape profile of the measurement target based on a focal position of the wavelength of the reflected light signal.

### CROSS-REFERENCE TO RELATED APPLICATION

This application is based on and claims priority under 35 U.S.C. § 119 to Korean Patent Application Nos. 10-2024-0138028, filed on Oct. 10, 2024, and 10-2024-0176901, filed on Dec. 2, 2024, in the Korean Intellectual Property Office, the disclosures of each of which are incorporated by reference herein in their entireties.

### BACKGROUND

The inventive concept relates to a shape profile measurement device, a shape profile measurement method, and a semiconductor device manufacturing method including the same, and more particularly, to a shape profile measurement device using an interference signal, a shape profile measurement method using an interference signal, and a semiconductor device manufacturing method including the same.

As semiconductor device integration has increased, vertical semiconductor device structures have been proposed as alternatives to conventional planar structures. Vertical-structured semiconductor devices include a channel structure extending in the vertical direction on a substrate. However, as semiconductor device integration has increased, the number of vertically stacked layers has also grown, creating a need for more precise measurement methods for semiconductor devices.

### SUMMARY

The inventive concept provides a shape profile measurement device with improved reliability, a shape profile measurement method with improved reliability, and a semiconductor device manufacturing method including the same.

The problems to be solved by the technical idea of the inventive concept are not limited to the problems mentioned above, and other problems could be clearly understood by those of ordinary skill in the art from the description below.

According to an aspect of the present disclosure, a shape profile measurement device includes a light source configured to generate and emit a light signal, a relay optical system configured to receive the light signal from the light source, perform axial chromatic aberration on the light signal, emit a chromatically dispersed light signal over a plurality of wavelengths to a measurement target, and output a reflected light signal reflected from the measurement target, wherein the chromatically dispersed light signal is focused at different positions along an optical axis of the light signal, a detector configured to detect a wavelength of the reflected light signal, among the plurality of wavelengths, received from the relay optical system; and a processor configured to calculate a shape profile of the measurement target based on a focal position of the wavelength of the reflected light signal, wherein the measurement target comprises a front surface having a pattern formed thereon and a back surface that is opposite to the front surface, and the light signal is incident to the back surface of the measurement target.

According to an aspect of the present disclosure, a shape profile measurement device includes a first light source configured to generate and emit a first light signal, a second light source configured to generate and emit a second light signal, a relay optical system configured to receive the first light signal from the first light source and the second light signal from the second light source, perform axial chromatic aberration on the first light signal, emit a chromatically dispersed light over a plurality of wavelengths to a measurement target and the second light signal to the measurement target, and output a reflected first light signal reflected from the measurement target and a reflected second light signal reflected from the measurement target, wherein the reflected first light signal corresponds to the first light signal, wherein the reflected second light signal corresponds to the second light signal, and wherein the chromatically dispersed light is focused at different positions along an optical axis of the first light signal received from the first light source, a first detector configured to receive the reflected first light signal reflected from the measurement target and detect a wavelength of the reflected first light signal among the plurality of wavelengths, a second detector configured to detect the reflected second light signal reflected from the measurement target; and a processor configured to calculate a shape profile of the measurement target based on a focal position of the wavelength of the reflected first light signal and a planar image of the measurement target based an intensity of the reflected second light signal, wherein the measurement target comprises a front surface having a pattern formed thereon and a back surface that is opposite to the front surface, and the light signal is incident to the back surface of the measurement target.

According to an aspect of the present disclosure, a shape profile measurement method includes placing a measurement target on a stage, wherein the measurement target includes a front surface at which patterns are formed and a back surface opposite to the front surface, generating and emitting a first light signal having a wavelength band of a plurality of wavelengths, performing axial chromatic aberration on the first light signal to generate a chromatically dispersed light signal over the plurality of wavelengths, emitting the chromatically dispersed light signal to the measurement target, wherein the chromatically dispersed light signal travels from the back surface of the measurement target to the front surface of the measurement target, detecting a first wavelength of the chromatically dispersed light signal reflected from the back surface of the measurement target and a second wavelength of the chromatically dispersed light signal reflected from the front surface of the measurement target, and calculating a surface profile of the front surface of the measurement target based on a first focal position of the first wavelength and a second focal position of the second wavelength.

### BRIEF DESCRIPTION OF THE DRAWINGS

Embodiments of the inventive concept will be more clearly understood from the following detailed description taken in conjunction with the accompanying drawings in which:

FIG. 1 illustrates a shape profile measurement device according to some embodiments;

FIG. 2 illustrates a shape profile measurement device according to some embodiments;

FIG. 3 illustrates an effect of a light signal having a chromatic aberration, according to some embodiments;

FIG. 4 is a cross-sectional view of a measurement target including a pattern, according to some embodiments;

FIG. 5 illustrates a shape profile measurement method according to some embodiments;

FIG. 6 is a graph showing the intensity of an interference signal according to a wavelength, according to some embodiments;

FIG. 7 illustrates a shape profile measurement device according to some embodiments;

FIG. 8 is a top view of a planar image of a measurement target, which is acquired by a second detector, according to some embodiments;

FIG. 9 illustrates a shape profile measurement device according to some embodiments;

FIG. 10 is a flowchart illustrating a shape profile measurement method according to some embodiments;

FIG. 11 is a schematic block diagram of a shape profile measurement device according to some embodiments; and

FIG. 12 is a flowchart illustrating a semiconductor device manufacturing method including a shape profile measurement method, according to some embodiments.

### DETAILED DESCRIPTION OF THE EMBODIMENTS

Hereinafter, embodiments are described in detail with reference to the accompanying drawings. Like reference numerals in the drawings denote like elements, and thus their repetitive description will be omitted. In the drawings, the thicknesses or sizes of layers are exaggerated for convenience and clarity of description, and accordingly, may be somewhat different from actual shapes and ratios.

The terms, e.g., “beneath”, “below”, “under”, “on”, and “above”, indicating positions in a space are to describe the relative position relationships between elements or patterns shown in the drawings, are only for easiness of understanding, and do not have any intention to limit the technical idea of the inventive concept. The terms for the relative positions in a space intend to include changes according to a direction of a semiconductor device in addition to a direction described in the drawings. That is, the semiconductor device may be oriented in various directions in use (or in manufacturing), and even in this case, the terms for positions used in the specification will be easily understood by those of ordinary skill in the art.

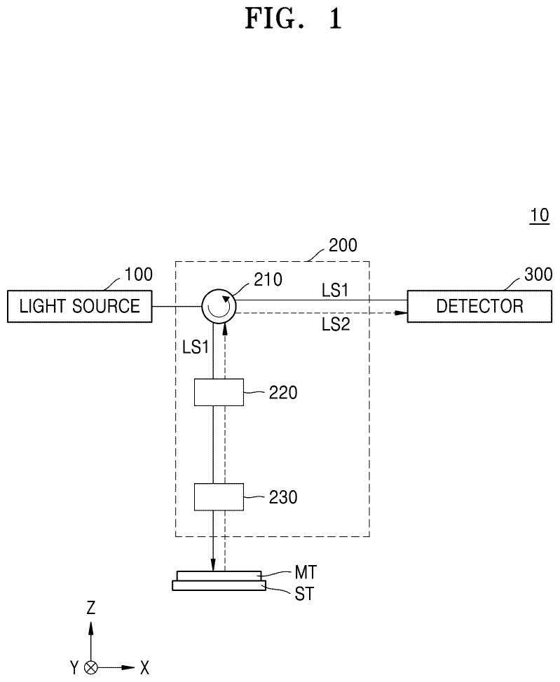

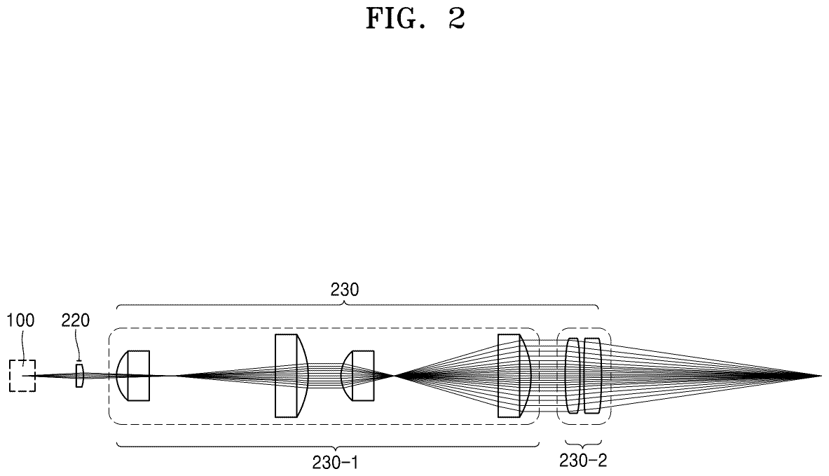

FIG. 1 illustrates a shape profile measurement device 10 according to some embodiments. FIG. 2 illustrates a shape profile measurement device 10 according to some embodiments.

Referring to FIGS. 1 and 2, the shape profile measurement device 10 may include a light source 100, a relay optical system 200, and a detector 300. The shape profile measurement device 10 may measure the shape profile of a measurement target MT based on a light signal reflected from the measurement target MT including a pattern. The shape profile measurement device 10 may apply a light signal to the measurement target MT. The measurement target MT may have a front side at which patterns are formed and a back side with a flat surface. The measurement target MT may be placed on a stage ST such that the back side of the measurement target MT faces toward the relay optical system 200 emitting a light signal toward the measurement target MT. The light signal may travel through the measurement target MT, being reflected at the back side and the front side which correspond to an interface between two materials (e.g., silicon and air) having different refractive indices, where the light signal is reflected. I shape profile (i.e., a surface profile) of the front surface with patterns of the measurement target MT may be measured based on a light signal reflected from the back surface and the front surface. For example, the shape profile may be a three-dimensional shape profile of the front side with patterns. In an embodiment, an optical axis of the light signal emitted from the relay optical system 200 toward the measurement target MT may be perpendicular to the back side of the measurement target MT. In an embodiment, the light signal emitted from the relay optical system 200 may be chromatically dispersed light over a plurality of wavelengths, and the reflected light from the measurement target MT may have a wavelength that is focused at the back side of the measurement target MT, the front side thereof, or bottom surfaces of the patterns formed at the front side.

The light source 100 may generate and emit light. The light source 100 may be configured to emit a first light signal LS1. The light source 100 may include a laser light source, and the laser light source may be a femtosecond laser configured to generate a femtosecond-scale light signal. For example, the light source 100 may include a mode-locked laser (MLL), a super-luminescent diode (SLD), an optical frequency comb, a titanium (Ti)-sapphire laser, and/or a second harmonic generation (SHG) laser.

The light source 100 may be configured to output a light signal of a wavelength band having a high transmittance with respect to the measurement target MT. It is desirable to use a light signal with high transmittance so that the light signal travels through the measurement target MT (e.g., from the back side to the front side). The greater the transmittance through the measurement target MT, the stronger the intensity of the light signal reflected from its front surface, thereby enabling the detector 300 to detect the reflected signal more accurately. In some embodiments, the light source 100 may be configured to output a light signal of a wavelength band having a high transmittance with respect to silicon. For example, the light source 100 may be configured to output a light signal having a wavelength of about 1,000 nm to about 2,500 nm. The light source 100 may generate and emit a light signal having high coherence. For example, the light signal emitted from the light source 100 may be coherent light signal such as a multi-wavelength or broadband laser beam. The relay optical system 200 may include an axial chromatic aberration generator which may spatially disperse the different wavelengths present in the light signal (e.g., the broadband laser beam). Wavelengths of the chromatically dispersed light signal may have different focal positions along an optical axis of the light signal emitted from the relay optical system 200. The axial chromatic aberration generator will be discussed below. When the measurement target MT is measured using a light signal having high coherence, an interference signal generated from the measurement target MT may be easily analyzed. The interference signal may result from two or more wavelengths of the light signal reflected from the measurement target MT. In an embodiment, the interference signal may result from at least two reflected light signals among a light signal reflected from the back surface of the measurement target MT, a light signal reflected from the front surface of the measurement target MT, and a light signal reflected from bottom surfaces of the patterns formed at the front side of the measurement target MT.

In another embodiment, the light source 100 may generate and emit a light signal having low coherence. In this case, an additional device configured to grant coherence to the light signal generated by the light source 100. For example, the shape profile measurement device 10 may further include an optical resonator and a mode-locking device.

The relay optical system 200 may allow the light signal generated by the light source 100 to be incident to the measurement target MT. The relay optical system 200 may relay a light signal reflected from the measurement target MT to the detector 300. The relay optical system 200 may include an optical circulator 210, a collimator 220, and a chromatic aberration control system 230.

The optical circulator 210 (i.e., a light deflector) may control the path (i.e., a traveling path) of the first light signal LS1. For example, the optical circulator 210 may change the path of the first light signal LS1 such that the first light signal LS1 is incident to the measurement target MT. For example, the optical circulator 210 may change a traveling direction of the first light LS1 emitted from the light source 100. The optical circulator 210 may include at least one of a reflective surface (e.g., a mirror) and a refractive element (e.g., a prism or lens) that alters the traveling path of the first light LS1.

The collimator 220 may receive the first light signal LS1. The collimator 220 may form the first light signal LS1 to be parallel. The collimator 220 may align light emitted at a focal position to be parallel. In some embodiments, the collimator 220 may include a lens and/or a mirror.

The chromatic aberration control system 230 may receive the first light signal LS1 output from the collimator 220. The chromatic aberration control system 230 may control the chromatic aberration of the first light signal LS1. The chromatic aberration control system 230 may control the first light signal LS1 such that the first light signal LS1 has an axial chromatic aberration. Therefore, the chromatic aberration control system 230 may control the first light signal LS1 such the first light signal LS1 has a different focal position for each wavelength band. In some embodiments, the chromatic aberration control system 230 may control the first light signal LS1 such that the first light signal LS1 has a different focal position for each wavelength band in the vertical direction (the Z direction). In an embodiment, wavelengths in the wavelength band may have different focal positions in the optical axis of the first light signal LS1, which is parallel to the vertical direction (the Z direction).

In the specification, the direction in which the first light signal LS1 is incident to the measurement target MT is defined as the vertical direction (the Z direction). Alternatively, a direction parallel to the main surface of the measurement target MT is defined as a horizontal direction (the X direction and/or the Y direction), and a direction perpendicular to the horizontal direction (the X direction and/or the Y direction) is defined as the vertical direction (the Z direction).

The chromatic aberration control system 230 may include a first system 230-1 and a second system 230-2. A light signal input to the chromatic aberration control system 230 may be first input to the first system 230-1 and then relayed to the second system 230-2. The first system 230-1 may include a beam expander and a chromatic aberration generator.

The beam expander may receive the first light signal LS1 and control the diameter of the beam of the first light signal LS1. For example, the beam expander may change the diameter of the collimated first light signal generated from the collimator 220. The beam expander may include one or more lenses. In some embodiments, the beam expander may increase the diameter of the beam of the first light signal LS1 output from the collimator 220. In another embodiment, the beam expander may decrease the diameter of the beam of the first light signal LS1 output from the collimator 220. In some embodiments, the beam expander may be omitted.

The chromatic aberration generator may receive the first light signal LS1 outputted from the beam expander and may be configured as described above such that chromatic aberration occurs in the first light signal LS1 outputted from the beam expander. The chromatic aberration generator may make a chromatic aberration occur in the first light signal LS1 by using the refractive index of light. For example, the chromatic aberration generator may include a prism, a lens, and/or a diffraction grating. In an embodiment, the chromatic aberration generator is configured to deliberately introduce axial chromatic aberration to the first light signal LS1, thereby focusing different wavelengths at distinct positions along the optical axis of the first light signal LS1. By analyzing the wavelength of the reflected light, the distance to a surface of a measurement target can be determined. The surface may correspond to an interface between materials having different refractive indices, where the first light signal LS1 is reflected.

The second system 230-2 may focus a light signal. For example, the second system 230-2 may focus the first light signal LS1 on one focal point. In some embodiments, the second system 230-2 may include one or more lenses.

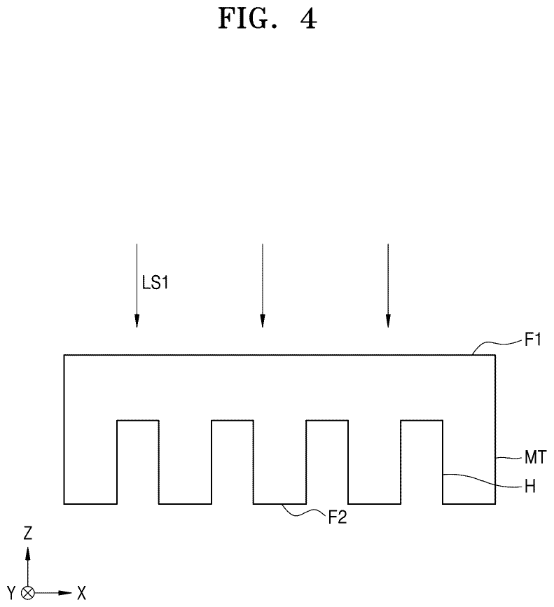

The measurement target MT to be measured by the shape profile measurement device 10 may include a pattern. In some embodiments, the measurement target MT may include a high aspect ratio contact (HARC) pattern. The measurement target MT including the pattern is described in more detail with reference to FIG. 4.

The shape profile measurement device 10 may further include a stage ST. The stage ST may support the measurement target MT to be measured. The stage ST may move the measurement target MT in the horizontal direction (the X direction and/or the Y direction) and/or the vertical direction (the Z direction) or rotate the measurement target MT around the vertical direction (the Z direction) as an axis such that the measurement target MT is aligned with respect to the relay optical system 200 configured to relay the first light signal LS1.

A second light signal LS2 reflected from the measurement target MT may be input to the detector 300 through the optical circulator 210. The detector 300 may detect the second light signal LS2 reflected from the measurement target MT. In some embodiments, the detector 300 may include measurement equipment capable of analyzing the wavelength spectrum of the second light signal LS2. For example, the detector 300 may include an optical spectrum analyzer (OSA). The detector 300 may acquire the shape profile of the measurement target MT based on the second light signal LS2.

The detector 300 may measure the measurement target MT based on the second light signal LS2 reflected from the measurement target MT. The detector 300 may measure the measurement target MT based on an interference signal.

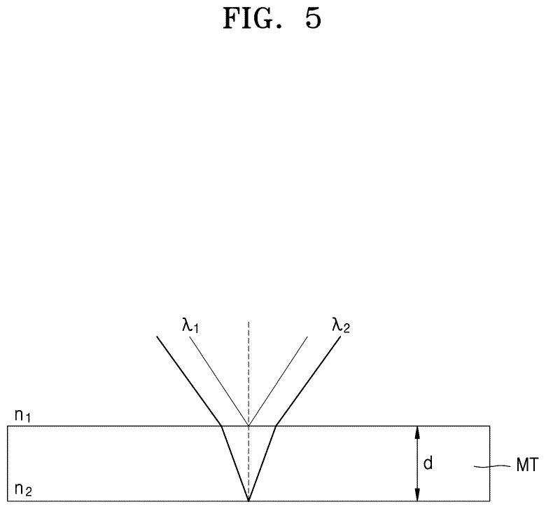

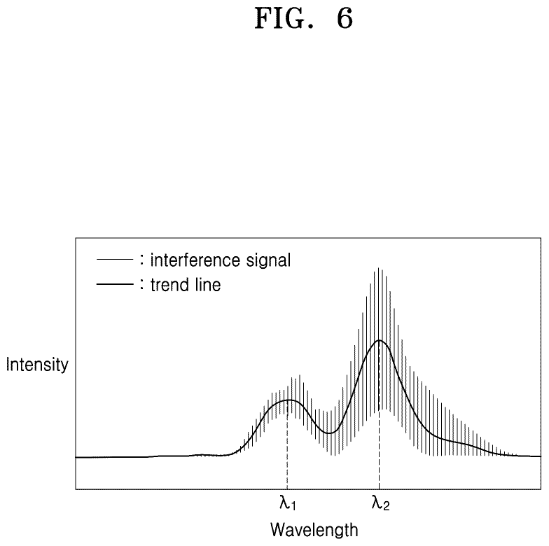

A method, performed by the detector 300, of measuring the measurement target MT based on the wavelength spectrum of the second light signal LS2 is described in more detail with reference to FIGS. 5 and 6. In some embodiments, the detector 300 may include a filter configured to pass only a partial wavelength band therethrough. The filter included in the detector 300 is described in more detail with reference to FIGS. 5 and 6.

The shape profile measurement device 10 may make a chromatic aberration occur in a light signal, allow the light signal to be incident to the back surface of the measurement target MT, and then measure the measurement target MT based on an interference signal of the light signal. The shape profile measurement device 10 may measure the measurement target MT based on a light signal of a wavelength band having a high transmittance with respect to the measurement target MT.

In more detail, the shape profile measurement device 10 of the inventive concept may measure the measurement target MT based on light signals reflected from different vertical positions in the measurement target MT. Therefore, the shape profile measurement device 10 may measure the measurement target MT based on a light signal having an axial chromatic aberration (e.g., a chromatic aberration in the vertical direction (the Z direction)).

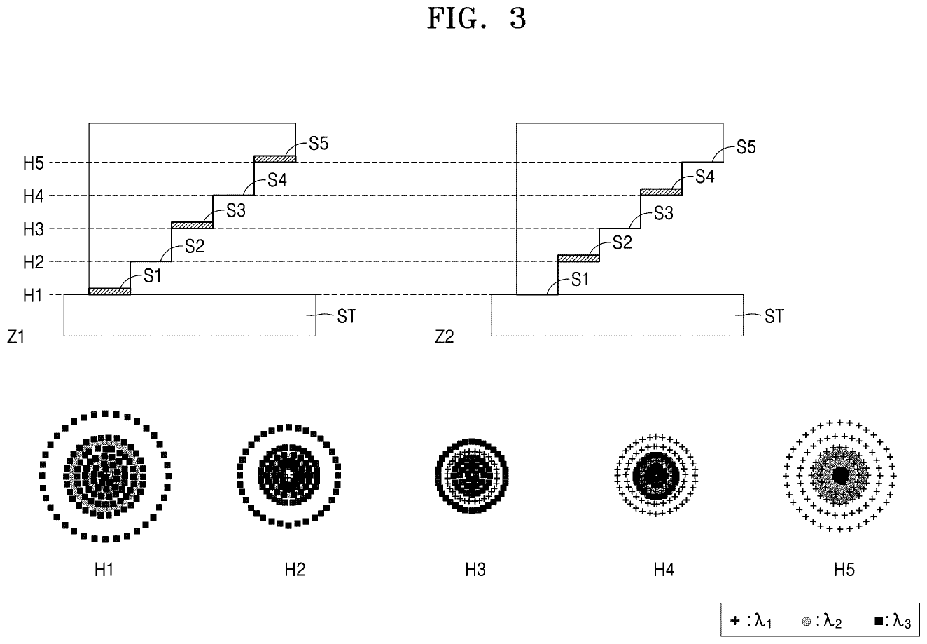

FIG. 3 illustrates an effect of a light signal having a chromatic aberration, according to some embodiments.

FIG. 3 shows wavelength-specific optical focal points at different vertical levels. First to third wavelengths λ₁, λ₂, and λ₃ are different from each other. For example, the first to third wavelengths may be included in the chromatically dispersed light signal by the chromatic aberration control system 230. First to fifth vertical levels H1, H2, H3, H4, and H5 are different from each other. A description is made with reference to FIGS. 1 and 2 together.

Referring to FIG. 3, a light signal of the first wavelength λ₂ may have a focal point at (that is, may be focused on) the first vertical level H1. The light signal of the first wavelength λ₂ may not have a focal point at (that is, may be defocused on) the second to fifth vertical levels H2, H3, H4, and H5. A light signal of the second wavelength λ₂ may have a focal point at the third vertical level H3. The light signal of the second wavelength λ₂ may not have a focal point at the first, second, fourth, and fifth vertical levels H1, H2, H4, and H5 with reference to the stage ST positioned at a first height Z1 in the vertical direction Z. A light signal of the third wavelength λ₃ may have a focal point at the fifth vertical level H5. The light signal of the third wavelength λ₃ may not have a focal point at the first to fourth vertical levels H1, H2, H3, and H4.

Therefore, when chromatic aberrations occur in a light signal, light signals focused on various vertical levels may be acquired. For the simplicity of description, the measurement target MT having five surfaces S1 to S5 is placed on the stage ST which is positioned at a first height Z1 in the vertical direction Z. For example, when a first surface S1 of the measurement target MT is positioned at the first vertical level H1, the first surface S1 of the measurement target MT may be measured using the light signal of the first wavelength λ₁. At the first surface S1 where the measurement target MT is exposed to air (or the stage ST), the light of the first wavelength λ1 may be reflected and subsequently detected by the detector 300. For example, when a third surface S3 of the measurement target MT is positioned at the third vertical level H3, the third surface S3 of the measurement target MT may be measured using the light signal of the second wavelength λ₂. At the third surface S3 where the measurement target MT is exposed to air, the light of the second wavelength λ₂ may be reflected and subsequently detected by the detector 300. For example, when a fifth surface S5 of the measurement target MT is positioned at the fifth vertical level H5, the fifth surface S5 of the measurement target MT may be measured using the light signal of the third wavelength λ₃. At the fifth surface S5 where the measurement target MT is exposed to air, the light of the third wavelength λ₃ may be reflected and subsequently detected by the detector 300.

The shape profile measurement device 10 of the inventive concept may measure multiple surfaces of the measurement target MT positioned at various vertical levels while minimizing movement of the measurement target MT in the vertical direction (the Z direction). For example, the stage ST may be lowered to a second height Z2, and then the second surface S2 and the fourth surface S4 may be measured using the first wavelength λ₁ and the second wavelength λ₂, respectively. This process may enable generation of a surface profile of the measurement target MT having the first to five surfaces S1 to S5. As described in detail later, the shape profile measurement device 10 of the inventive concept may acquire light signals reflected from different vertical levels. Therefore, the measurement target MT may be easily measured using a light signal having a chromatic aberration.

FIG. 4 is a cross-sectional view of the measurement target MT including a pattern, according to some embodiments.

Referring to FIG. 4, the measurement target MT may include a first face F1 and a second face F2 that is opposite to the first face F1. The first face F1 may be spaced apart from the second face F2 in the vertical direction (the Z direction). The measurement target MT may include the pattern. In some embodiments, the measurement target MT may include one or more holes H formed by removing at least a portion of the measurement target MT in the vertical direction (the Z direction). The first face F1 may be the back surface of the measurement target MT, and the second face F2 may be the front surface of the measurement target MT. The front surface of the measurement target MT may be a surface at which the pattern is formed, and the back surface of the measurement target MT may be a surface that is opposite to the front surface.

As described above, the first light signal LS1 for measuring the measurement target MT may be first incident to the first face F1 of the measurement target MT. That is, the first light signal LS1 may be first incident to the back surface of the measurement target MT. Because the first light signal LS1 is incident to the back surface of the measurement target MT, as the ratio of a light signal transmitting through the measurement target MT increases, the shape profile measurement device 10 may measure the measurement target MT with high reliability. Therefore, the shape profile measurement device 10 may measure the measurement target MT based on a light signal of a wavelength band having a high transmittance with respect to the measurement target MT.

In some embodiments, the measurement target MT may be manufactured from a wafer W. The measurement target MT may be manufactured by forming a pattern (e.g., the one or more holes H) on the wafer W. For example, the measurement target MT may include silicon.

The detector 300 may measure the measurement target MT based on a light signal reflected from the back surface of the measurement target MT and a light signal reflected from the bottom surface of the pattern. The detector 300 may measure the measurement target MT based on an interference signal between the light signal reflected from the back surface of the measurement target MT and the light signal reflected from the bottom surface of the pattern. A method, performed by the detector 300, of measuring the measurement target MT based on the interference signal is described with reference to FIGS. 5 and 6.

FIG. 5 illustrates a shape profile measurement method according to some embodiments. A description is made with reference to FIGS. 1 to 4 together.

Referring to FIG. 5, paths of two light signals having different wavelengths are shown. The light signal having the first wavelength λ₁ may be reflected from one surface of the measurement target MT (e.g., the back surface of the measurement target MT), and the light signal having the second wavelength λ₂ may be reflected from the other surface of the measurement target MT (e.g., the bottom surface of a hole H).

As described above, when a chromatic aberration occurs in a light signal to be incident to the measurement target MT, light signals of different wavelengths may have focal points positioned at different vertical levels, respectively. For example, the light signal having the first wavelength λ may have a focal point positioned at the back surface of the measurement target MT, and the light signal having the second wavelength λ₂ may have a focal point positioned at the bottom surface of a hole H. For example, a focal position of the first wavelength λ may be positioned at the back surface F2, and the reflection at the boundary between the back surface F2 and the outside such as air and the stage ST may be maximized. A focal position of the second wavelength λ₂ may be positioned at the bottom surface of the hole H, and the reflection at the boundary between the bottom surface of the hole H and an air may be maximized.

The shape profile of the measurement target MT may be measured using a distance d between the two surfaces of the measurement target MT. The distance d may be measured based on mathematical formulae 1 to 3. The distance d may be the distance from the back surface of the measurement target MT to the bottom surface of a pattern. First, an optical path length may be represented by mathematical formula 1 below.

[Mathematical formula 1]

$${d}_{int} = d \times {n}_{2} \times {k}_{1}$$

Herein, dᵢₙₜ denotes an optical path length, d denotes a distance, n₂ denotes the refractive index of the measurement target MT, and k₁ denotes a scaling factor. The scaling factor is the numerical aperture (NA) of the shape profile measurement device 10 and/or a parameter related to optical alignment of the shape profile measurement device 10. In an embodiment, the parameter “d” may correspond to a thickness of a portion of the measurement sample MT.

A difference d_{conf} between the first wavelength λ₁ and the second wavelength λ₂ may be represented by mathematical formula 2 below.

$${d}_{conf} = d \times \frac{{n}_{1}}{{n}_{2}} \times \frac{{[ 1 - {( \frac{NA}{{n}_{1}} )}^{2} ]}^{\frac{1}{2}}}{{[ 1 - {( \frac{NA}{{n}_{1}} )}^{2} ]}^{\frac{1}{2}}} \qquad [ Mathematical formula 2 ]$$

Herein, d_{conf} denotes the difference between the first wavelength λ₁ and the second wavelength λ₂, d denotes a distance (i.e., a thickness of the measurement sample MT as shown in FIG. 5), n₁ denotes an external refractive index, n₂ denotes the refractive index of the measurement target MT, and NA denotes the NA of the shape profile measurement device 10.

The distance d may be represented by mathematical formula 3 based on an interference distance (the optical path length dᵢₙₜ) and the wavelength difference d_{conf}.

$$[ Mathematical formula 3 ]$$

$$d = {( \frac{{NA}^{2} {d}_{conf}^{2} - {[ {NA}^{4} {d}_{conf}^{4} + [ 4 ( 1 - {NA}^{2} ) {d}_{int}^{2} {d}_{conf}^{2} ] ]}^{\frac{1}{2}}}{- 2 ( 1 - {NA}^{2} )} )}^{\frac{1}{2}}$$

Herein, d denotes a distance, NA denotes the NA of the shape profile measurement device 10, d_{conf} denotes the difference between the first wavelength λ₁ and the second wavelength λ2, and dᵢₙₜ denotes an optical path length.

Therefore, even when the refractive index of the measurement target MT is unknown, the distance d of the measurement target MT may be measured. Therefore, the shape profile measurement device 10 of the inventive concept may measure the shape profile of the measurement target MT with high reliability. In an embodiment, when the measurement target MT is formed of multi-layered structure including multiple layers having different materials, the effective refractive index of the measurement target MT may depend on relative thicknesses of the multiple layers. The shape profile measurement device 10 may measure the shape profile of the measurement target MT having multiple layers, without identifying an effective refractive index of the measurement target MT.

As described above, the detector 300 may include a filter. The filter may transmit only the first wavelength λ₁ and the second wavelength λ₂ therethrough.

FIG. 6 is a graph showing the intensity of an interference signal according to a wavelength, according to some embodiments. In FIG. 6, the horizontal axis indicates a wavelength, and the vertical axis indicates the intensity of light. Each of the horizontal axis and the vertical axis are shown using arbitrary unit (a.u.). A description is made with reference to FIGS. 1 to 5 together.

Referring to FIG. 6, an interference signal according to a wavelength is shown. A trend line according to the intensity of the interference signal is also shown. The trend line may have one or more peaks. FIG. 6 illustrates a case where the trend line has two peaks.

The optical path length dᵢₙₜ may be measured based on the period of the interference signal. The Fourier transform and inverse Fourier transform may be performed on the graph in FIG. 6. After this, the final result may be unwrapped to obtain the graph of frequency versus phase. The optical path length dᵢₙₜ may be represented by mathematical formula 4 below.

$${d}_{int} = \frac{c}{4 π} \times \frac{d ϕ ( v )}{dv} \qquad [ Mathematical formula 4 ]$$

Herein, dᵢₙₜ denotes an optical path length, c denotes speed of light,

$$\frac{d ϕ ( v )}{dv}$$

denotes the slope of the graph of frequency versus phase.

The difference d_{conf} between the first wavelength λ₁ and the second wavelength λ₂ may be calculated based on an interference signal graph. For convenience of description, a peak having a lower wavelength between the two peaks may be referred to as a first peak, and a peak having a higher wavelength between the two peaks may be referred to as a second peak. The wavelength corresponding to the first peak may be the first wavelength λ₁, and the wavelength corresponding to the second peak may be the second wavelength λ₂.

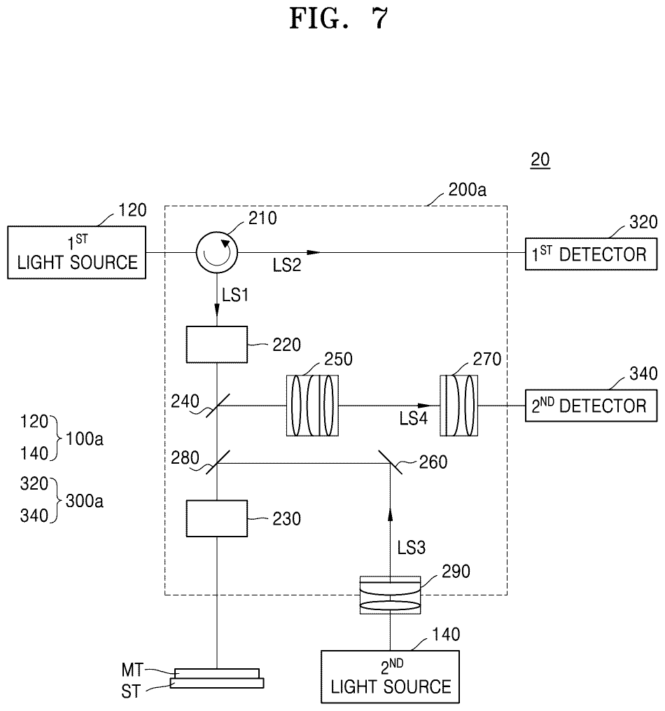

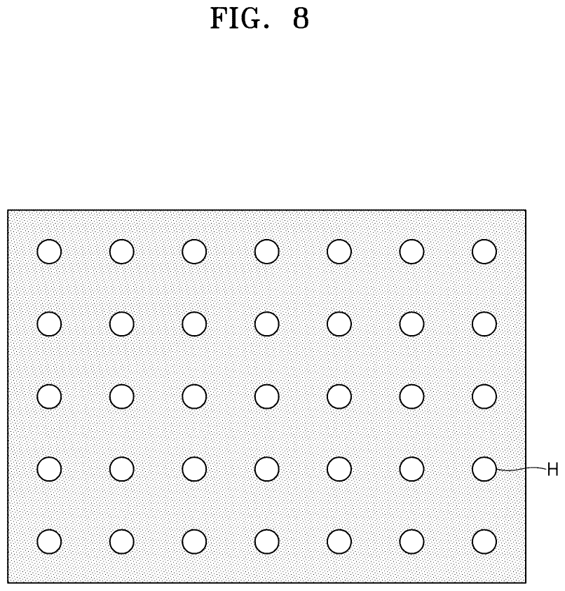

FIG. 7 illustrates a shape profile measurement device 20 according to some embodiments. FIG. 8 is a top view of a planar image IM of the measurement target MT, which is acquired by a second detector 340, according to some embodiments. A description is made with reference to FIG. 1 together.

The shape profile measurement device 20 of FIG. 7 is substantially the same as the shape profile measurement device 10 of FIG. 1 except that the former further includes a second light source 140, a compensation optical system 250, a focusing optical system 270, a diverging lens system 290, and the second detector 340, and thus, differences between the shape profile measurement device 10 of FIG. 1 and the shape profile measurement device 20 of FIG. 7 are mainly described.

Referring to FIGS. 7 and 8, the shape profile measurement device 20 may include a light source 100a, a relay optical system 200a, and a detector 300a. The light source 100a may include a first light source 120 and the second light source 140. The first light source 120 may be substantially the same as the light source 100 of the shape profile measurement device 10 of FIG. 1.

The second light source 140 may generate and emit light. The second light source 140 may generate and emit light for acquiring an image of the measurement target MT. The second light source 140 may be configured to output a light signal of a wavelength band having a high transmittance with respect to the measurement target MT. In some embodiments, the second light source 140 may be configured to output a light signal of a wavelength band having a high transmittance with respect to silicon. For example, the second light source 140 may be configured to output a light signal having a wavelength of about 1,000 nm to about 2,500 nm. The second light source 140 may generate and emit light having low coherence. For example, the second light source 140 may generate and emit light of a wide wavelength band. For example, the second light source 140 may include a light-emitting diode (LED) and/or a lamp. In some embodiments, a degree of the coherence of the first light signal LS1 generated and emitted by the first light source 120 may be higher than a degree of the coherence of a third light signal LS3 generated and emitted by the second light source 140.

The relay optical system 200a may allow the light generated by the first light source 120 and/or the second light source 140 to be incident to the measurement target MT. The relay optical system 200a may relay a light signal reflected from the measurement target MT to the detector 300a. The relay optical system 200 may include the optical circulator 210, the collimator 220, the chromatic aberration control system 230, a first mirror 240, the compensation optical system 250, a second mirror 260, a third mirror 280, a diverging lens system 290 and the focusing optical system 270. The optical circulator 210, the collimator 220, and the chromatic aberration control system 230 may be substantially the same as described above.

The first mirror 240 and the second mirror 260 may selectively control the path of a light signal. The second mirror 260 and the third mirror 280 may change the traveling path of the third light signal LS3 generated by the second light source 140 such that the third light signal LS3 is incident to the measurement target MT. In more detail, the third light signal LS3 generated by the second light source 140 may be incident to the measurement target MT sequentially through the second mirror 260 and the third mirror 280 without traveling through the compensation optical system 250. The first mirror 240 may change the traveling path of a fourth light signal LS4 to be incident to the second detector 340, the fourth light signal LS4 being generated when the third light signal LS3 is reflected from the measurement target MT. The fourth light signal LS4 may be input to the second detector 340 through the first mirror 240, the compensation optical system 250, the second mirror 260, and the focusing optical system 270.

The compensation optical system 250 may control the chromatic aberration of the fourth light signal LS4. Because the third light signal LS3 is incident to the measurement target MT through the chromatic aberration control system 230, a chromatic aberration may occur in the third light signal LS3. Therefore, to compensate for the chromatic aberration, the shape profile measurement device 20 of the inventive concept may further include the compensation optical system 250. That is, the compensation optical system 250 may reduce the chromatic aberration of the fourth light signal LS4.

For example, the compensation optical system 250 may include an achromatic lens, an apochromatic lens, a diffractive optical element (DOE), and/or an aspheric lens. However, the technical idea of the inventive concept is not limited thereto, and other types of optical elements may be used.

The focusing optical system 270 may focus the fourth light signal LS4 on one focal point. In some embodiments, the focusing optical system 270 may include one or more lenses. For example, the focusing optical system 270 may control the fourth light signal LS4 such that the focal point of the fourth light signal LS4 is positioned on the bottom surface of a pattern.

The diverging lens system 290 may diverge the third light LS3. In some embodiments, the diverging lens system 290 may include one or more lenses. However, the technical idea of the inventive concept is not limited thereto, and other types of optical elements may be used.

The detector 300a may include a first detector 320 and the second detector 340. The first detector 320 may be substantially the same as the detector 300 of the shape profile measurement device 10 of FIG. 1. The second detector 340 may detect the fourth light signal LS4. The second detector 340 may acquire an image of the measurement target MT. The second detector 340 may acquire the planar image IM of the measurement target MT based on the third light signal LS3 generated and emitted by the second light source 140. That is, the second detector 340 may acquire the planar image IM of the measurement target MT and two-dimensionally detect the position of a pattern (e.g., a hole H). That is, the second detector 340 may acquire a two-dimensional image of the measurement target MT. In an embodiment, the planar image of the measurement target MT may be obtained by illuminating the measurement target MT with a visible light source and detecting the reflected light across a two-dimensional area of the measurement target MT. The present disclosure is not limited thereto. In an embodiment, the planar image of the measurement target MT may be obtained using a laser as the light source, especially in techniques that benefit from the laser's coherence and intensity, such as scanning microscopy or profilometry.

The second detector 340 may control the relay optical system 200a such that the bottom surface of the hole H is in focus. As shown in FIG. 8, the position of the hole H on the planar image IM of the measurement target MT may be acquired.

The shape profile measurement device 20 of the inventive concept may acquire a three-dimensional profile image by using the first detector 320 and acquire a two-dimensional planar image by using the second detector 340. Therefore, the measurement target MT may be measured with high reliability.

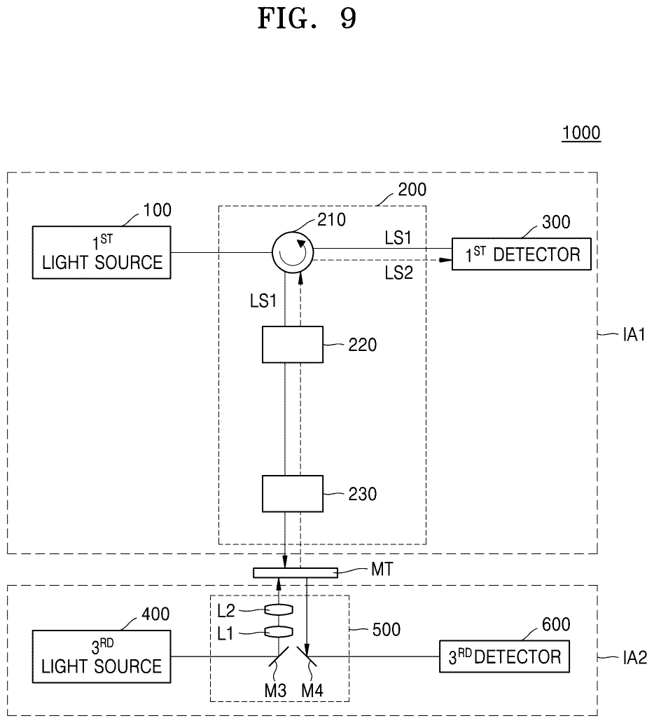

FIG. 9 illustrates a shape profile measurement device 1000 according to some embodiments. A description is made with reference to FIGS. 1 to 8 together.

Referring to FIG. 9, the shape profile measurement device 1000 may include a first shape profile measurement device IA1 and a second shape profile measurement device IA2. The first shape profile measurement device IA1 may be configured to measure the measurement target MT by applying light onto the back surface of the measurement target MT, and the second shape profile measurement device IA2 may be configured to measure the measurement target MT by applying light onto the front surface of the measurement target MT. The first shape profile measurement device IA1 may include at least one of the shape profile measurement devices 10 and 20 of FIGS. 1 and 8.

The first shape profile measurement device IA1 and the second shape profile measurement device IA2 may measure the measurement target MT by using different wavelength bands of light. In some embodiments, the first shape profile measurement device IA1 may measure the measurement target MT based on a light signal of a wavelength band having a high transmittance with respect to the measurement target MT, and the second shape profile measurement device IA2 may measure the measurement target MT based on a light signal of a wavelength band having a high reflectivity with respect to the measurement target MT.

The first shape profile measurement device IA1 may include a first light source 100, a first relay optical system 200, and a first detector 300, and the second shape profile measurement device IA2 may include a third light source 400, a second relay optical system 500, and a third detector 600. The first light source 100, the first relay optical system 200, and the first detector 300 of the first shape profile measurement device IA1 are substantially the same as the light source 100, the relay optical system 200, and the detector 300 of FIG. 1, and thus, a detailed description thereof is omitted herein. As described above, the first shape profile measurement device IA1 may measure the measurement target MT by applying a light signal onto the back surface of the measurement target MT.

The third light source 400 may generate and emit a light signal for measuring the measurement target MT. The second relay optical system 500 may be configured such that the light signal generated by the third light source 400 is incident to the measurement target MT. The second relay optical system 500 may be configured to relay a light signal reflected from the measurement target MT to the third detector 600. In some embodiments, the second relay optical system 500 may be configured such that the light signal generated by the third light source 400 is incident to the front surface of the measurement target MT. The third detector 600 may be configured to measure the measurement target MT based on a light signal reflected from the front surface of the measurement target MT. The second shape profile measurement device IA2 may measure the measurement target MT based on a light signal of a wavelength band having a high reflectivity with respect to the measurement target MT.

The shape profile measurement device 1000 of the inventive concept may measure the measurement target MT by allowing a light signal to be incident to each of the front surface and the back surface of the measurement target MT. Therefore, the measurement target MT may be measured with high reliability. The shape profile measurement device 1000 of the inventive concept may perform measurement based on different wavelength bands respectively applied to the upper surface and the lower surface of the measurement target MT.

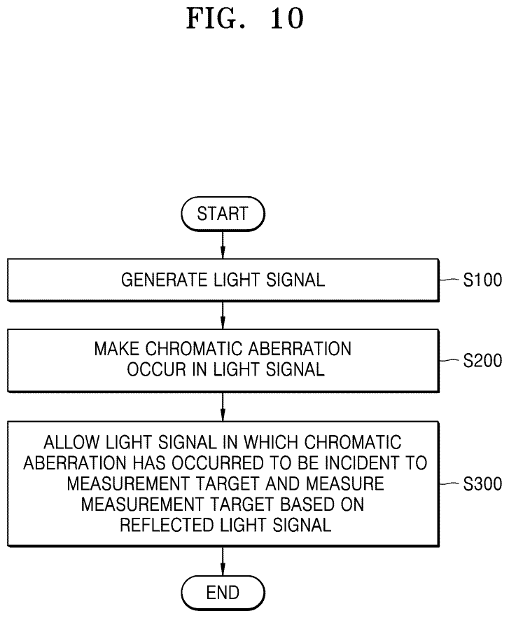

FIG. 10 is a flowchart illustrating a shape profile measurement method according to some embodiments. A description is made with reference to FIGS. 1 to 9 together.

Referring to FIG. 10, first, a light signal for measuring the measurement target MT may be generated in operation S100. The light signal may have a wavelength band having a high transmittance with respect to the measurement target MT. In some embodiments, the light signal may have a wavelength band having a high transmittance with respect to silicon. For example, the light signal may have a wavelength of about 1,000 nm to about 2,500 nm.

Thereafter, a chromatic aberration may occur in the light signal in operation S200. An axial chromatic aberration may occur in the light signal. When the axial chromatic aberration occurs in the light signal, the light signal may have a different focal position for each wavelength band. For example, the chromatic aberration may occur in the light signal by a beam expander, a chromatic aberration generator, and/or a lens.

Thereafter, the light signal in which the chromatic aberration has occurred may be incident to the measurement target MT, and then the measurement target MT may be measured based on a reflected light signal in operation S300. Operation S300 may be performed based on an interference signa between a light signal reflected from the back surface of the measurement target MT and a light signal reflected from the bottom surface of a hole H. In more detail, an optical path length may be measured based on the interference signal. Based on the interference signal, the first wavelength λ₁ of which the focal position is positioned on the back surface of the measurement target MT and the second wavelength λ₂ of which the focal position is positioned on the bottom surface of the pattern may be detected. The shape profile of the measurement target MT may be measured based on the parameters.

The difference between the first wavelength λ₁ of which the focal position is positioned on the back surface of the measurement target MT and the second wavelength λ₂ of which the focal position is positioned on the bottom surface of the hole H may be measured. The distance from the back surface of the measurement target MT to the bottom surface of the hole H may be measured based on process parameters of semiconductor processes associated with the formation of the measurement target MT. Therefore, the shape profile of the measurement target MT may be acquired. In some embodiments, a planar image of the measurement target MT may be additionally acquired.

The measurement target MT may be measured based on the shape profile acquired in operation S300. The acquired shape profile may be compared to a designed shape profile based on the process parameters. If the difference is within an allowable error range, the measurement target MT may be determined to be normal. If the difference exceeds the allowable range, the measurement target MT may be determined to be abnormal. The designed shape profile may be a target profile which may be obtained by simulation or obtained from a target device with the target profile.

If it is determined that the measurement target MT is abnormal, a post process on the measurement target MT may be performed. For example, a process of manufacturing the measurement target MT may be corrected. For example, correcting the process of manufacturing the measurement target MT may include correcting a parameter of the process of manufacturing the measurement target MT.

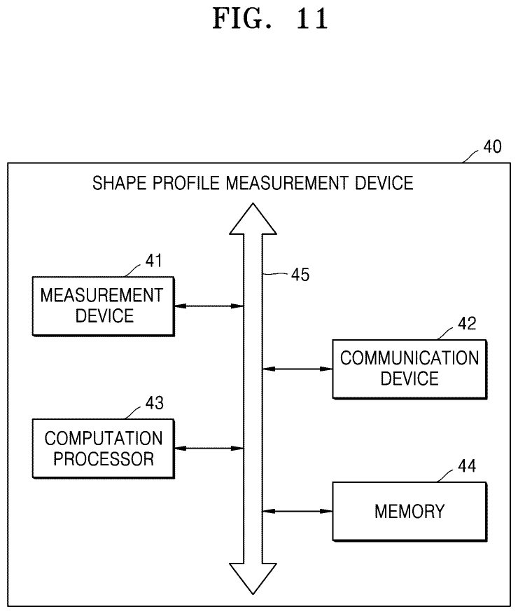

FIG. 11 is a schematic block diagram of a shape profile measurement device 40 according to some embodiments. A description is made with reference to FIGS. 1 to 10 together.

Referring to FIG. 11, the shape profile measurement device 40 may include a measurement device 41, a communication device 42, a computation processor 43, a memory 44, and a bus 45. However, the components included in the shape profile measurement device 40 are not limited to the components listed above, and the shape profile measurement device 40 may include other components configured to measure a shape profile. The components included in the shape profile measurement device 40 may communicate with each other via the bus 45.

The measurement device 41 may measure the measurement target MT including a pattern. For example, the measurement device 41 may include a device configured to measure the measurement target MT based on an interference signal generated when a light signal is reflected from the measurement target MT. For example, the measurement device 41 may include a light source configured to generate and emit a light signal of a wavelength band having a high transmittance with respect to the measurement target MT. For example, the measurement device 41 may generate a light signal having a wavelength of about 1,000 nm to about 2,500 nm.

The communication device 42 may provide network communication to the shape profile measurement device 40. A network for the network communication may be a wired network and/or a wireless network, such as a radio network, a cellular network, a satellite network, and/or a broadcast network. In an embodiment, the shape profile measurement device 40 may be an electrical device in which an image processing program is installed, such as a computer, a smartphone, a personal computer, or a server.

The computation processor 43 may perform computation on data acquired by the measurement device 41. The computation processor 43 may measure an optical path length based on the interference signal. The computation processor 43 may measure, based on the interference signal, the difference between the first wavelength λ₁ of which the focal position is positioned on the back surface of the measurement target MT and the second wavelength λ₂ of which the focal position is positioned on the bottom surface of a hole H. The computation processor 43 may measure the distance from the back surface of the measurement target MT to the bottom surface of the hole H based on the process parameters. The computation processor 43 may perform computation on the shape profile of the measurement target MT.

In some embodiments, the computation processor 43 may perform computation on a two-dimensional image acquired by the measurement device 41. The computation processor 43 may measure the position of the hole H in a top view.

For example, the computation processor 43 may include a central processing unit (CPU), a graphics processing unit (GPU), a vector processor, a quantum computation processor, or an embedded computation processor.

The memory 44 may store data computed by the computation processor 43. The memory 44 may store data acquired by the measurement device 41. For example, the memory 44 may include flash memory, a hard disk drive (HDD), a solid state drive (SSD), dynamic random access memory (DRAM), or static random access memory (SRAM).

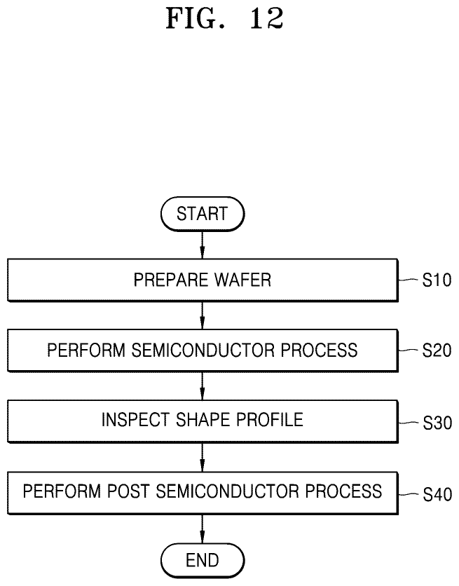

FIG. 12 is a flowchart illustrating a semiconductor device manufacturing method including a shape profile measurement method, according to some embodiments. A description is made with reference to FIGS. 1 to 11 together.

Referring to FIG. 12, first, the wafer W may be prepared in operation S10. For example, one or more semiconductor processes have been performed on the wafer W, or the wafer W may include a bare wafer on which no semiconductor process has been performed.

Thereafter, a semiconductor process may be performed on the wafer W in operation S20. An oxidation process, a photo process, a deposition process, an etching process, an ionization process, and/or a cleaning process may be performed on the wafer W. A pattern may be formed on the wafer W by performing the semiconductor process on the wafer W. In some embodiments, at least a portion of the wafer W may be removed in the vertical direction (the Z direction) to form a pattern extending in the vertical direction (the Z direction). In another embodiment, a plurality of layers may be formed on the wafer W, and then at least some of the plurality of layers may be removed in the vertical direction (the Z direction) to form a pattern extending in the vertical direction (the Z direction).

Thereafter, a shape profile may be inspected in operation S30. Operation S30 of inspecting the shape profile may include operation S100 of generating a light signal, operation S200 of making a chromatic aberration occur in the light signal, and operation S300 of allowing the light signal to be incident to the measurement target MT and then measuring the measurement target MT based on the light signal in FIG. 10.

Thereafter, a post semiconductor process may be performed on the wafer W in operation S40. The post semiconductor process on the wafer W may include various processes. For example, the post semiconductor process may include an oxidation process, a photo process, a deposition process, an etching process, an ionization process, or a cleaning process. The post semiconductor process may include a singulation process of individualizing the wafer W into individual semiconductor chips, a test process of testing the semiconductor chips, and a packaging process of packaging the semiconductor chips. A semiconductor device may be completed through the post semiconductor process on the wafer W.

While the inventive concept has been particularly shown and described with reference to embodiments thereof, it will be understood that various changes in form and details may be made therein without departing from the spirit and scope of the following claims.

What is claimed is:

1. A shape profile measurement device comprising:
a light source configured to generate and emit a light signal;
a relay optical system configured to receive the light signal from the light source, perform axial chromatic aberration on the light signal, emit a chromatically dispersed light signal over a plurality of wavelengths to a measurement target, and output a reflected light signal reflected from the measurement target, wherein the chromatically dispersed light signal is focused at different positions along an optical axis of the light signal;
a detector configured to detect a wavelength of the reflected light signal, among the plurality of wavelengths, received from the relay optical system; and
a processor configured to calculate a shape profile of the measurement target based on a focal position of the wavelength of the reflected light signal,
wherein the measurement target comprises a front surface having a pattern formed thereon and a back surface that is opposite to the front surface, and the light signal is incident to the back surface of the measurement target.

2. The shape profile measurement device of claim 1,
wherein the relay optical system comprises a chromatic aberration control system configured to perform the axial chromatic aberration on the light signal emitted from the light source, and
wherein the chromatic aberration control system comprises at least one of a prism, a lens, and a diffraction grating performing the axial chromatic aberration.

3. The shape profile measurement device of claim 2,
wherein the chromatic aberration control system further comprises at least one of:
a beam expander configured to control a diameter of the light signal emitted from the light source; and
a lens configured to focus the light signal emitted from the light source.

4. The shape profile measurement device of claim 1,
wherein the detector is configured further to receive an interference signal of two or more reflected wavelengths, among the plurality of wavelengths, reflected from the measurement target.

5. The shape profile measurement device of claim 1,
wherein the light signal emitted from the light source includes a coherent light signal.

6. The shape profile measurement device of claim 1,
wherein the light signal emitted from the light source has a wavelength band of about 1,000 nm to about 2,500 nm.

7. The shape profile measurement device of claim 1,
wherein the light source comprises a femtosecond laser configured to generate a femtosecond-scale light signal, and
wherein the femtosecond-scale light signal corresponds to the light signal generated from the light source.

8. A shape profile measurement device comprising:
a first light source configured to generate and emit a first light signal;
a second light source configured to generate and emit a second light signal;
a relay optical system configured to receive the first light signal from the first light source and the second light signal from the second light source, perform axial chromatic aberration on the first light signal, output a chromatically dispersed light over a plurality of wavelengths to a measurement target and the second light signal to the measurement target, and output a reflected first light signal reflected from the measurement target and a reflected second light signal reflected from the measurement target, wherein the reflected first light signal corresponds to the first light signal, wherein the reflected second light signal corresponds to the second light signal, and wherein the chromatically dispersed light is focused at different positions along an optical axis of the first light signal received from the first light source;
a first detector configured to receive the reflected first light signal reflected from the measurement target and detect a wavelength of the reflected first light signal among the plurality of wavelengths;
a second detector configured to detect the reflected second light signal reflected from the measurement target; and
a processor configured to calculate a shape profile of the measurement target based on a focal position of the wavelength of the reflected first light signal and a planar image of the measurement target based an intensity of the reflected second light signal,
wherein the measurement target comprises a front surface having a pattern formed thereon and a back surface that is opposite to the front surface, and the light signal is incident to the back surface of the measurement target.

9. The shape profile measurement device of claim 8,
wherein the first detector is configured further to receive an interference signal of two or more reflected wavelengths, among the plurality of wavelengths, reflected from the measurement target.

10. The shape profile measurement device of claim 8,
wherein the relay optical system comprises one or more lenses configured to focus the first light signal emitted from the first light source.

11. The shape profile measurement device of claim 8,
wherein the relay optical system comprises:
a chromatic aberration control system configured to perform the axial chromatic aberration on the second light signal emitted from the second light source; and
a compensation optical system configured to reduce the axial chromatic aberration of the second light signal reflected from the measurement target, and
wherein the relay optical system outputs the second light signal with the reduced axial chromatic aberration as the second light signal outputted from the relay optical system.

12. The shape profile measurement device of claim 8, further comprising:
a stage supporting the measurement target,
wherein the second light signal, emitted from the second light source, is directed to the measurement target below the stage configured to pass the second light signal.

13. The shape profile measurement device of claim 8,
wherein a degree of coherence of the first light signal emitted from the first light source is higher than a degree of coherence of the second light signal emitted from the second light source.

14. The shape profile measurement device of claim 8,
wherein each of the first light signal emitted from the first light source and the second light signal emitted from the second light source has a wavelength band of about 1,000 nm to about 2,500 nm.

15. The shape profile measurement device of claim 8,
wherein the first light source comprises at least one of a mode-locked laser, an optical frequency comb, a titanium (Ti)-sapphire laser, and a second harmonic generation (SHG) laser.

16. A shape profile measurement method comprising:
placing a measurement target on a stage, wherein the measurement target includes a front surface at which patterns are formed and a back surface opposite to the front surface;
generating and emitting a first light signal having a wavelength band of a plurality of wavelengths;
performing axial chromatic aberration on the first light signal to generate a chromatically dispersed light signal over the plurality of wavelengths;
emitting the chromatically dispersed light signal to the measurement target, wherein the chromatically dispersed light signal travels from the back surface of the measurement target to the front surface of the measurement target;
detecting a first wavelength of the chromatically dispersed light signal reflected from the back surface of the measurement target and a second wavelength of the chromatically dispersed light signal reflected from the front surface of the measurement target; and
calculating a surface profile of the front surface of the measurement target based on a first focal position of the first wavelength and a second focal position of the second wavelength.

17. The shape profile measurement method of claim 16, further comprising:
measuring an optical path length based on a period of an interference signal of the chromatically dispersed light signal reflected from the back surface of the measurement target and the chromatically dispersed light signal reflected from the front surface of the measurement target; and
measuring a plurality of wavelengths corresponding to a plurality of peaks of the interference signal,
wherein the calculating of the surface profile of the front surface of the measurement target includes calculating a distance from the back surface of the measurement target to a bottom surface of a pattern of the measurement target based on the optical path length and the plurality of wavelengths corresponding to the plurality of peaks of the interference signal.

18. The shape profile measurement method of claim 17,
wherein the calculating of the distance from the back surface of the measurement target to the bottom surface of the pattern of the measurement target is performed based on a difference between the plurality of wavelengths corresponding to the plurality of peaks.

19. The shape profile measurement method of claim 16, further comprising:
generating and emitting a second light signal and then acquiring a planar image of the measurement target by allowing the second light signal to be incident to the back surface of the measurement target.

20. The shape profile measurement method of claim 16, further comprising:
performing filtering to detect the first wavelength of which a focal position is positioned on the back surface of the measurement target and a third wavelength of which a focal position is positioned on a bottom surface of a pattern formed at the front surface of the measurement target.
